(19) United States
(12) Patent Application Publication
(10) Pub. No.: US 2003/0002966 A1
(43) Pub. Date: Jan. 2, 2003

(54) Apparatus for transport of refuse from residence or other desired areas to designated refuse collection site and return back to residence for reuse

(76) Inventor: William Dale Porter, Cocoa Beach, FL (US)

Correspondence Address: William Dale Porter, c/o Richard Porter, 105 Iris Street, Goose Creek, SC, 29445, US

(21) Appl. No.: 09/881,689

(22) Filed: Jun. 18, 2001

(51) Int. Cl. B65G 65/23

(52) U.S. Cl. 414/421; 414/389; 104/118

(57) ABSTRACT

This invention relates to an automatic domestic trash delivery system extending between chosen refuse container storage and designated pick-up site. This invention is to provide a domestic refuse delivery system that can be emptied by garbage pick-up service, more specifically the trucks with the automatic lift and dump apparatus.

### CROSS-REFERENCE TO RELATED APPLICATIONS

| | | | |
|---|---|---|---|
| 5,042,642 | August 1991 | Ulrich | 198/750.1 |
| 5,353,887 | October 1994 | Putnam | 180/168. |

### STATEMENT REGARDING FEDERALLY SPONSORED RESEARCH OR DEVELOPMENT

“Not Applicable”

### REFERENCE TO MICROFICHE APPENDIX

“Not Applicable”

### BACKGROUND OF THE INVENTION

This invention relates to an automatic domestic trash delivery system extending between chosen refuse container storage and designated pick-up site. This invention is to provide a domestic refuse delivery system that can be emptied by garbage pick-up service, more specifically the trucks with the automatic lift and dump apparatus.

In Ullrich, U.S. Pat. No. 5,042,642, for a household trash delivery system on a track, in which the cart is moved by continuous chain conveyor. Another system is described in Putnam, U.S. Pat. No. 5,353,887 in which the motor is housed in the cart and has a drive wheel located on the under side of the cart drivable on a track at set times using a programmable timer.

The disadvantages of the prior art for track mounted vehicles, is that vehicles do not have the support necessary for the impact of the automatic lift apparatuses which are applied to the collection vehicles to assist the collection process. Prior art of the Ullrich and Putnam patents show complex installation of the track which is a burden to the marketability. Further more, the Putnam patent provides an impractical method to overcome snow, where if the level of snow were to accumulate higher than a small mound in a short period of time, the cart would be inoperative.

Another drawback of the prior art is when the owner could be vacant from the home for any amount of time and the carrier takes the container to the curbside empty causing the collection vehicle to assume there is garbage in the barrel and accumulating time, they are giving effort to save, with the new automatic lifts.

### BRIEF SUMMARY OF THE INVENTION

The present invention consist of a timer controlled tracked vehicle for carrying refuse storage containers, having spring and shock action applied to the cart for durability to accommodate the automatic lifts which are progressively being applied to the garbage collection vehicles.

The object of this invention is to:

a) provide a controlled refuse receptacle carrier, that is compatible with the mechanical lifts on the garbage collection trucks;

b) allow the carrier to endure the harsh force of the automatic vehicles;

c) provide a programmable garbage carrier, which may be moved in two directions to transport receptacles between a residence and the collection site;

d) to inform the driver by providing visible notification on the cart when the container is empty;

e) provide safety bumpers along the sides of the carrier to pause when in contact with a an obstacle while in motion, until the obstacle has moved.

f) provide predetermined controls to establish transport times of the carrier;

g) have a horizontal hollow track with elongated surface to hold fixed to the ground being manufactured in to sectional pieces which are strait and curved to allow carrier to travel along any desired pattern;

h) apply light materials and snap together track pieces to allow for easy assembly by any common individual;

i) provide an option of heat in the track surface to avoid snow and ice build up by pipes containing boiling water being heated by a small broiler;

### BRIEF DESCRIPTION OF THE SEVERAL VIEWS OF THE DRAWING

FIG. 1 shows a side view of a timer programmable apparatus for transporting domestic refuse containers.

FIG. 2 shows a front view of the apparatus showing guidance through a hollow track.

FIG. 3 shows a rear view of the apparatus showing the drive.

FIG. 4 shows an under carriage view of the apparatus.

FIG. 5 shows an over head view of the track.

FIG. 6 shows a three dimensional view of the track channel.

FIG. 7 shows operations of mechanical parts.

### DETAILED DESCRIPTION OF THE INVENTION

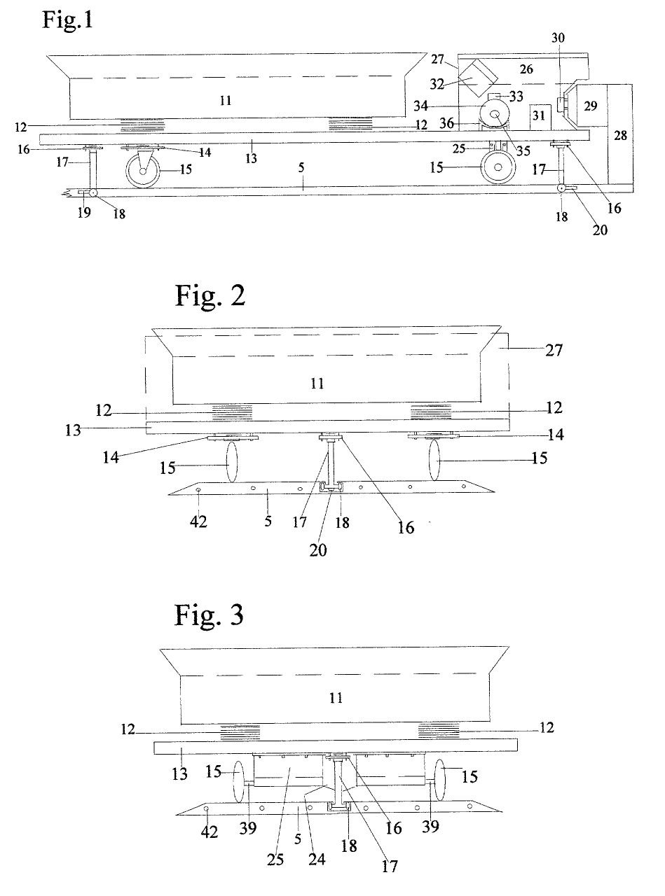

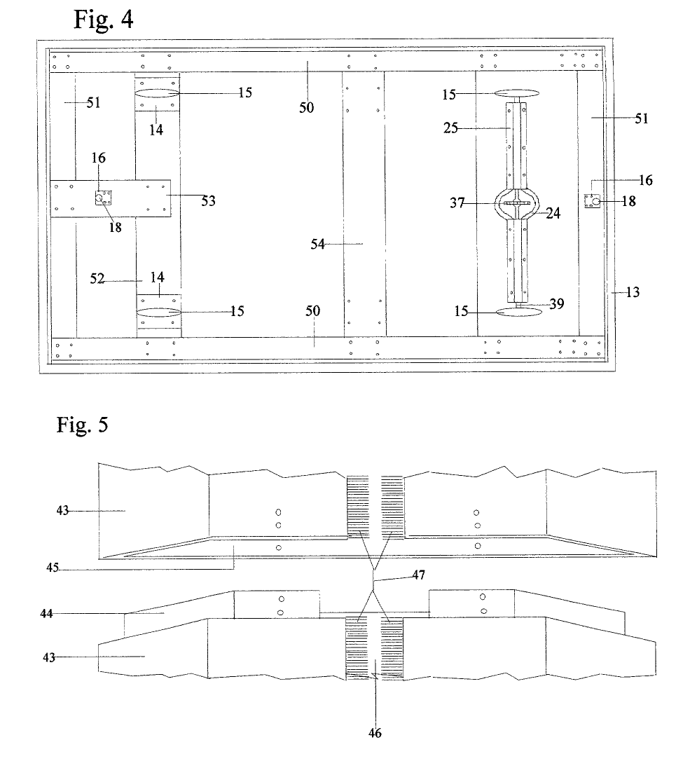

FIG. 1 shows a timer 32 programmable apparatus 1 for transporting refuse that comprises of a delivery service that can hold a large refuse container and durable to be used with the mechanical lifts on the collection trucks. Where as the carrier 1 travels along the track beginning at a desired refuse container storage location, and ending at the refuse collection site, generally located at the curbside in front of a home. The system is made of light simple pieces to allow for box packaging for marketability and easy assembly by any individual.

The carrier 1 is framed with two ninety degree angled steel pieces 50 running parallel the length of the carrier and two pieces 51 that run parallel the width of the carrier to form a rectangular shaped outer frame. One side of the angle is supporting the container storage bin 11 and mechanical parts 7 and fastened to this outer angle 50 and 51 of the frame 4. The other side of the angle 50 and 51 will hang under the frame for attaching an endless safety bumper 13 using a tension cord wraps the sides of the frame 4. There is a slat of steel 52 that runs along the width in the front end, on top of the angle steel 50 frame 4 for the wheels 15 to be fastened to each side under the carrier farley spaced from the edges to roll on top of the track surface 43. There will be an additional slat of steel 53 connecting the slat 52 which the front wheels 15 are attached to the center of the front ninety degree angle steel piece 51 to fasten the guide wheels 18. A slat 54 of the same width of the frame 4 supported on the angled steel pieces 50 will be slightly off centered in the frame 4 to support the container storage bin 11. The box housing 27 the moving parts will be attached on top in the rear of the frame 4. The rear wheels 15 are mounted on an axle 39 for means of motion, the axle 39 is cased 25 on either side of the sprocket 37 which is attached to the motor 34, the sprocket 37 is also cased 24 and attached to the bottom of the motor housing 27. A guide 17 and 18 will also be attached to the bottom of the motor housing 27 and the rear piece of angled steel 51.

The front wheels 15 will roll on the track surface 43 and are mounted using swiveling spring supported brackets 14. The guidance rod 17 will also be secured to the frame using smaller spring supported brackets 16. The guide 17 and 18 will roll through a hollow track channel 46 on a pair of small wheels 18.

There are a pair heavy springs 12 mounted on top of the front steel slat 52 along the width of the carrier and another pair of heavy springs 12 mounted on the steel slat 54 along the width of the carrier. The heavy springs 12 will support the container storage bin 11 which holds the containers. The container storage bin 11 will be of size to hold large containers and will consist of a bottom and four sides. The sides will be angled to guide the barrel back into the container storage bin 11 easily. The container storage bin 11 will consist of a flat platform which will be enjoined together with eight durable slats. Hinges, will be used to secure four durable plastic slats to platform. Hinges will also secure the four additional upper slats allowing fold ability for easy packaging. The ends of the slats will be fastened with latches and two support braces attaching to angle steel exposed side and sides of slats. There is also provided a flag which can be turned up to notify the collection vehicles the container is full, and falls when the container is emptied which can be attached to a container. The box housing 27 which is attached to the end of the frame 50 and 51 will be the width of the frame 4. The box 27 will have a lid 22 which can be opened from the rear extending toward the front, on the top. Power is received from a common source and through a transformer set with a three prong female receptacle 29. The transformer 29 is braced to a pole 28 at the home end of the track and is lined up with the three prong male receptacle 30 mounted within a fitted indent, therefore there is a positive, negative and ground wire. The ground wire is immediately attached to frame, positive and negative wires are connected to the rechargeable battery 31 then from the battery to the control box 32. The control box 32 which is mounted at a slant in the box 27 at the top, level with the tool tray 26. The tool tray 26 is suspended over the motor 35 by sitting on five dowels extending from the bottom of the box 27. The control box 32 is connected to the toggle switches 13 and 33. The circuit breaks when toggle switches 13 and 33 are triggered. A weight switch mounted under the container can be used in place of the toggle switches 13 and 33. The switches 13 and 33 protrude from the base of the guide rod 17 and is flipped by another protruding piece in each end of the hollow track 6, and is reactivated by controls 32 at programmed times. The safety switch 13 consist of a soft rubber bumper housing an endless line if tension cord around the outer edge of the carrier 1. When tension is put on the safety switch 13 the circuit between the switch 13 and the compositor 34 breaks until tension is released. The switches 13, 19 and 20 are connected to the controls 32 through the compositor 34 and are always in connection. When the motor 35 is in motion it will turn the piston 36 in forward and reverse motion spinning an endless chain 38 around the a sprocket 39 which is mounted on the motor piston 36 and around a sprocket mounted on the axle 39 turning the rear wheels 15 for means of motion.

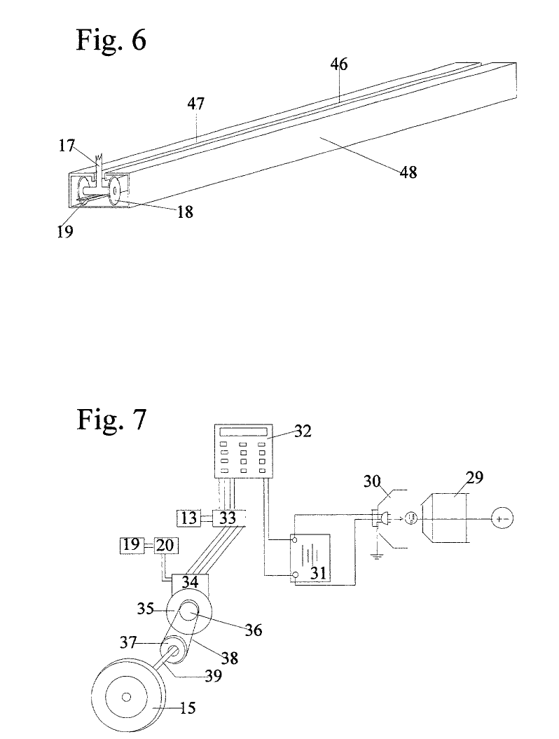

The track 5 lays on the ground and has a height of about two inches. The track surface 43 is as wide as the carrier 1 for the wheels 15 to roll. The track 5 has two ends starting from the storage location extending horizontally along the ground to the collection site located generally at the curb. There is a small hollow channel FIG. 6 mounted in the center of the track FIG. 5 which extends horizontally between both ends of the track. The top of the channel FIG. 6 will be flush with the top of the track surface 43 and open to allow the guide 17 to slide through. A brush 47 is attached to the length of the track FIG. 5 lined up with both sides of the opening of the channel 46 to avoid debris in the hollow channel FIG. 6. There will be drainage holes through the bottom of the body of the track FIG. 5 and the channel FIG. 6. The guide wheels 18 will roll in the hollow channel FIG. 6. The track FIG. 5 will be manufactured in various curved and strait pieces and will consist of pieces having male 44 and female 45 ends where one side is made slightly smaller than the other side for secure means of fastening to another piece of opposite male or female track piece 44 and 45. At each parked end of the track FIG. 5 a piece will slide on and fill the channel 46 with an elongated piece protruding in the length for means to flip the switch 19 or 20. Heat can be put in the track FIG. 5 using filoment heat in tubing 42 which is laced through the tracks body FIG. 5. The heat is only necessary in areas where snow would be an issue. The track FIG. 5 will be manufactured sections short enough for packaging and easy assembly. All pieces will be manufactured with light materials for easy handling. The outer track 43 will be made of a light plastic with little or no expansion. The channel FIG. 6 may be made of steel or aluminum.

I claim:

1. A domestic forward and reverse refuse delivery system, that comprises of:
a carrier which travels along a track beginning at a desired refuse container storage location, and ending at the refuse collection site.
a system which is made of light simple pieces to allow for box packaging for marketability and easy assembly by any individual.
a programmable automatic carrier extending between chosen refuse container storage and designated pick-up sites on a guided track and is controlled by electrical and mechanical means.
a delivery service which can hold a large refuse container and durable to be used with the mechanical lifts on the collection trucks.
a carrier built durable which can be emptied by garbage pick-up services equipped with the automatic lift and dump apparatus on the trucks.
